(19) United States
(12) Patent Application Publication
(10) Pub. No.: US 2014/0008188 A1
(43) Pub. Date: Jan. 9, 2014

(54) SWITCH UNIT AND GAME MACHINE

(71) Applicant: OMRON CORPORATION, Kyoto-shi (JP)

(72) Inventors: Hitoshi Sakamoto, Ichinomiya-shi (JP); Junya Fujita, Ichinomiya-shi (JP)

(73) Assignee: OMRON CORPORATION, Kyoto-shi (JP)

(21) Appl. No.: 14/007,038

(22) PCT Filed: Jan. 18, 2012
(86) PCT No.: PCT/JP2012/050947

§ 371 Date: Sep. 24, 2013

(30) Foreign Application Priority Data
Mar. 24, 2011 (JP) 2011-066102

(51) Int. Cl. H01H 13/83

(52) U.S. Cl. CPC H01H 13/83
USPC 200/61.1; 200/311

(57) ABSTRACT

A switch unit including operating keys, an LCD that displays an image, lenses that are disposed between the LCD and the operating keys and show the image displayed by the LCD on the operating surfaces of the operating keys, a PCB having contacts that detect when an operating key has been depressed, and a rubber that is disposed between the operating keys and the PCB.

### CROSS REFERENCE TO RELATED APPLICATION

This application is a U.S. National Phase application under 35 U.S.C. §371 of International Application No. PCT/JP2012/050947, filed on Jan. 18, 2012 and claims benefit of priority to Japanese Patent Application No. 2011-066102 filed on Mar. 24, 2011 of which the full contents are herein incorporated by reference.

### BACKGROUND OF THE INVENTION

The present invention relates to a switch unit, and particularly to a push-button switch unit and a game machine equipped with the same.

In a conventional slot machine, a plurality of reels are spun and each wheel displays a plurality of types of symbols. Then, a winning combination is determined on the basis of a matching pattern of symbols that are displayed when the reels are stopped, and a prize is given to a player according to the determined winning combination and the number of bets.

Operations such as the setting of the number of bets, and the spinning and stopping of reels have been performed by pressing a button. More specifically, a player presses a bet button with his/her hand to determine the number of bets, presses a reel spinning button with a hand to start the spin of reels, and presses a reel stopping button with the hand to stop the reels.

This type of conventional slot machine is placed in a casino and the like. Such casino includes slot machines manufactured by various game machine manufacturers. A player selects a slot machine that suits his or her preference from slot machines manufactured by various game machine manufacturers, and plays the selected one. Therefore, to remain competitive, each casino attempts to place slot machines that are popular to players. Therefore, each game machine manufacturer makes efforts to provide slot machines that appeal to players.

In view of this, there has been developed a slot machine that is provided with a display unit including a touch panel, such as that disclosed by Japanese Unexamined Patent Publication No. 2005-111137. In this slot machine, a character and a numeric keypad are displayed on the display unit, and the setting of the number of bets and the start of spin of reels are performed by using the touch panel.

However, in the above conventional configuration, since a player merely touches a screen, it is not possible to give an intuitive operational feeling to the player. The reason thereof is as follows.

In a conventional push-button switch unit, a player depresses a push button by the number of bets to be set, to thereby sensuously setting the number of bets. However, in the operation of a touch screen, it is necessary to confirm on the screen as to whether the number of bets has been correctly set by the touch in each operation. Therefore, a touch panel is inferior in operational feeling, click feeling, and quick feeling compared to a conventional push button. Accordingly, it is not possible to give an intuitive operational feeling to a player by way of a touch screen. In addition, if each operation of a touch screen slot machine takes a relatively longer time, then a time required for a single game will be increased.

### SUMMARY OF THE INVENTION

The present invention has been made in view of the above problems, and provides a switch unit and the like capable of attracting the attention of customers as well as giving an intuitive operational feeling to customers.

In order to solve the above problems, the switch unit according to the present invention includes an operating key, a display unit that displays an image, a lens that is disposed between the display unit and the operating key, and shows the image displayed on the display unit as being displayed on the operating surface of the operating key, a substrate having contacts that detect depression of the operating key when the operating key is depressed, and an elastic member that is disposed between the operating key and the substrate to make contact with both of the operating key and the substrate.

With the above configuration, it is possible to show a display on the display unit as being displayed on the operating surface of the operating key by the lens which is disposed between the display unit and the operating key. Therefore, it is possible to present various displays that can attract customers on the operating surface of the operating key. Accordingly, it is possible to provide a switch unit that attracts the attention of customers.

Further, since the elastic member is disposed between the operating key and the substrate, when the operating key is depressed, the elastic member is dented and then presses back the operating key. Accordingly, it is possible to give an intuitive operational feeling and a click feeling of depressing the operating key to a player. In addition, since an operation can be performed by a physical action such as depressing the operating key, it is not necessary to visually confirm whether the operation has been completed in each operation. Therefore, a switch unit that can give a speed feeling, a quick feeling, and a click feeling to a player can be provided.

As described above, the switch unit according to the present invention includes an operating key, a display unit that displays an image, a lens that is disposed between the display unit and the operating key, and shows the image displayed on the display unit as being displayed on the operating surface of the operating key, a substrate having contacts that detect depression of the operating key when the operating key is depressed, and an elastic member that is disposed between the operating key and the substrate to make contact with both of the operating key and the substrate.

Accordingly, an effect of providing a switch unit that attracts the attention of customers can be achieved. Further, an effect of giving an intuitive operational feeling and a click feeling of depressing an operating key to a player can be achieved. Furthermore, since an operation can be performed by a physical action such as depressing an operating key, it is not necessary to visually confirm whether the operation has been completed in each operation. Therefore, an effect of providing a switch unit that gives a speed feeling, a quick feeling, and a click feeling to a player can be achieved.

### BRIEF DESCRIPTION OF THE DRAWINGS

FIG. 1 is a perspective exploded view illustrating an embodiment of the present invention, and illustrating the configuration of a switch unit.

FIGS. 2(a) to 2(d) are diagrams illustrating a slot machine equipped with the switch unit, where FIG. 2(a) is a perspective view of the slot machine, FIG. 2(b) is a front view of the slot machine, FIG. 2(c) is a top view of the slot machine, and FIG. 2(d) is a side view of the slot machine.

FIG. 3 is a perspective exploded view of the switch unit.

FIGS. 4(a) to 4(c) are diagrams illustrating the appearance of the switch unit, where FIG. 4(a) is a top view of the switch unit, FIG. 4(b) is a side view of the switch unit, and FIG. 4(c) is a bottom view of the switch unit.

FIGS. 5(a) and 5(b) are perspective cross-sectional views illustrating the internal configuration of the switch unit.

FIGS. 6(a) to 6(f) are diagrams illustrating the internal configuration of the switch unit, where FIG. 6(a) is a cross-sectional view taken along line A-A of FIG. 4(a), FIG. 6(b) is a cross-sectional view taken along line B-B of FIG. 4(a), FIG. 6(c) is an enlarged view of an area K of FIG. 6(b), FIG. 6(d) is a cross-sectional view taken along line C-C of FIG. 4(a), FIG. 6(e) is a cross-sectional view taken along line E-E of FIG. 4(a), and FIG. 6(f) is a cross-sectional view taken along line G-G of FIG. 4(a).

FIGS. 7(a) to 7(d) are diagrams illustrating the appearance of a cover of the switch unit, where FIG. 7(a) is a top view of the cover, FIG. 7(b) is a front view of the cover, FIG. 7(c) is a side view of the cover, and FIG. 7(d) is a bottom view of the cover.

FIGS. 8(a) to 8(d) are diagrams illustrating the appearance of a case of the switch unit, where FIG. 8(a) is a top view of the case, FIG. 8(b) is a front view of the case, FIG. 8(c) is a side view of the case, and FIG. 8(d) is a bottom view of the case.

FIGS. 9(a) to 9(h) are diagrams illustrating the appearance of operating buttons of the switch unit, where FIG. 9(a) is a top view of an operating button that has a generally square shape when viewed from the top, FIG. 9(b) is a front view thereof, FIG. 9(c) is a side view thereof, FIG. 9(d) is a bottom view thereof, FIG. 9(e) is a top view of an operating button that has a rectangular shape when viewed from the top, FIG. 9(f) is a front view thereof, FIG. 9(g) is a side view thereof, and FIG. 9(h) is a bottom view thereof.

FIGS. 10(a) to 10(c) are diagrams illustrating the appearance of a lens of the switch unit, where FIG. 10(a) is a top view, FIG. 10(b) is a front view, and FIG. 10(c) is a side view.

FIGS. 11(a) to 11(c) are diagrams illustrating the appearance of a rubber of the switch unit, where FIG. 11(a) is a top view, FIG. 11(b) is a front view, and FIG. 11(c) is a bottom view.

FIGS. 12(a) to 12(c) are diagrams illustrating the appearance of a PCB of the switch unit, where FIG. 12(a) is a top view, FIG. 12(b) is a side view, and FIG. 12(c) is a bottom view.

FIGS. 13(a) to 13(d) are diagrams illustrating the appearance of an LCD case of the switch unit, where FIG. 13(a) is a top view, FIG. 13(b) is a front view, FIG. 13(c) is a side view, and FIG. 13(d) is a bottom view.

FIGS. 14(a) to 14(d) are diagrams illustrating the appearance of a base 19 of the switch unit, where FIG. 14(a) is a top view, FIG. 14(b) is a front view, FIG. 14(c) is a side view, and FIG. 14(d) is a bottom view.

### DETAILED DESCRIPTION

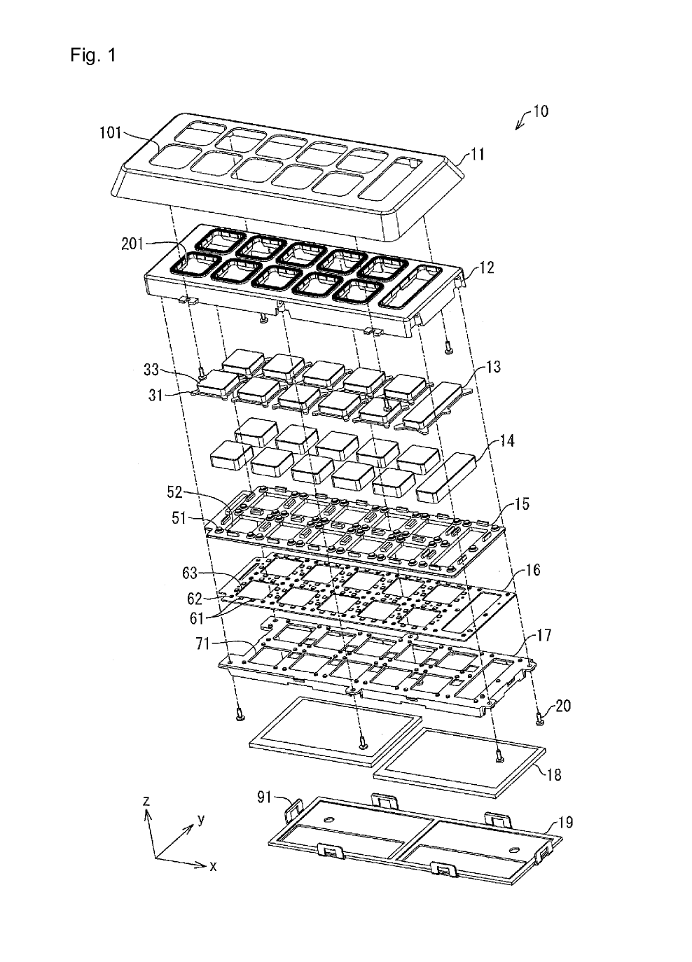

An embodiment of the present invention will be described with reference to FIGS. 1 to 14(d) as follows. In the present embodiment, although an operating switch unit used in a so-called slot machine will be described, the present invention is not limited thereto. The present invention can be applied to any devices that operate by receiving an operation by a user through a push-button switch. For example, the present invention can also be applied to a card game machine such as a poker game machine and a mahjong game machine.

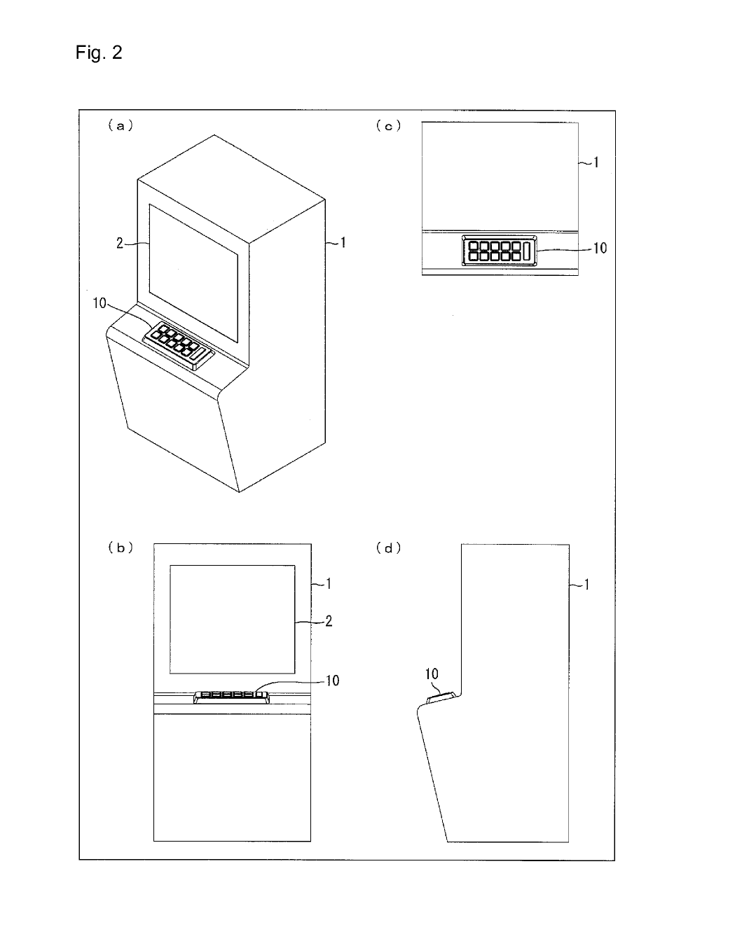

First, a switch unit 10 according to the present embodiment mounted on a slot machine (game machine) 1 will be described with reference to FIGS. 2(a) to 2(d). FIGS. 2(a) to 2(d) are diagrams illustrating the states of the switch unit 10 according to the present embodiment mounted on the slot machine 1. FIG. 2(a) is a perspective view of the slot machine 1, FIG. 2(b) is a front view of the slot machine 1, FIG. 2(c) is a top view of the slot machine 1, and FIG. 2(d) is a side view of the slot machine 1.

As shown in FIGS. 2(a) to 2(d), the slot machine 1 includes a display unit 2 which is provided at a position at player's eye level on the top part of a casing, and the switch unit 10 which is provided at a position near the center of the casing on which a hand of a player is placed in such a manner that an operating part thereof is slightly inclined toward a player.

A plurality of reels are displayed on the display unit 2. The reels are spun and stopped by operation of a player. According to symbols indicated on the stopped reels, a winning combination is determined and a prize is thereby given to a player. Equivalents of the reels may be displayed on a display screen. Alternatively, the reels themselves may be arranged on the display unit 2.

The switch unit 10 is operated by a player. For example, when a player plays the slot machine 1, the switch unit 10 receives operations such as the determination of the number of bets and the starting and stopping of spin of the reels. Details of the configuration of the switch unit 10 will be described below.

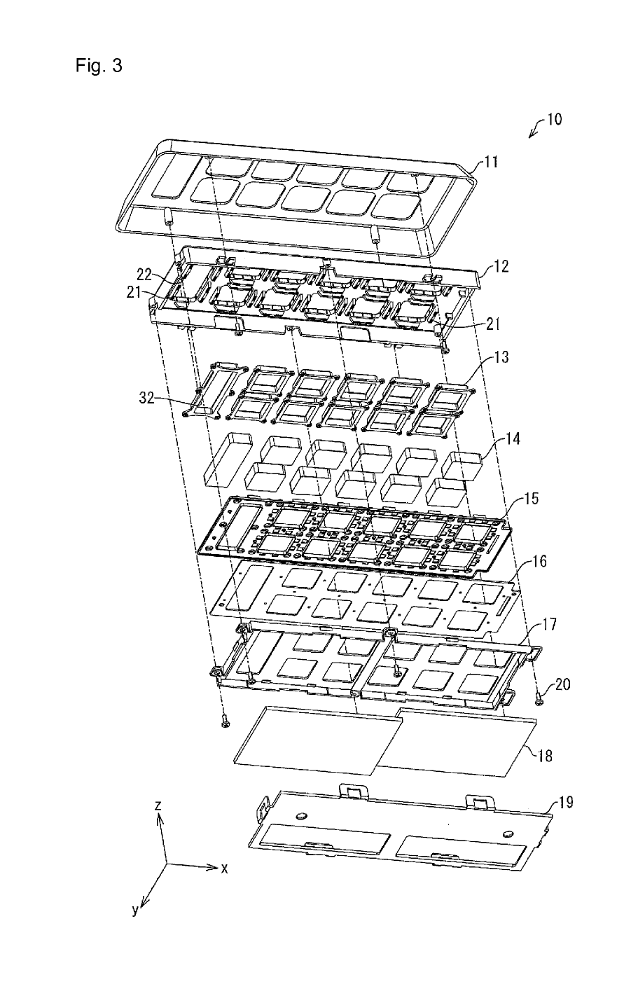

Next, the configuration of the switch unit 10 will be described with reference to FIG. 1, and FIGS. 3 to 14(d). FIGS. 1 and 3 are perspective exploded views of the switch unit 10. FIG. 1 illustrates the switch unit 10 viewed from the obliquely upward direction. FIG. 3 illustrates the switch unit 10 viewed from the obliquely downward direction. Hereinafter, the same side as an operating surface of the switch unit 10 is referred to as an upper side (top surface side), and the side opposite thereto is referred to as a lower side (bottom surface side). Further, a longitudinal direction when viewing the switch unit 10 from the upper side is referred to as an x direction, a lateral direction thereof is referred to as a y direction, and the upper direction of the switch unit 10 is referred to as a z direction. Further, a surface of the switch unit 10 viewed from the minus (−) y direction toward the plus (+) y direction is referred to as a front surface.

As shown in FIGS. 1 and 3, the switch unit 10 includes a cover 11, a button case (operating key case) 12, operating buttons (operating keys) 13, lenses 14, a rubber (elastic member) 15, a printed circuit board (PCB) 16, a liquid crystal display (LCD) case 17, an LCD (display unit) 18, and a base 19 which are arranged in this order from the top (from the +z direction). In addition, the button case 12 and the LCD case 17 are fixed to each other with screws 20, and the cover 11 and the button case 12 are also fixed to each other with screws 20.

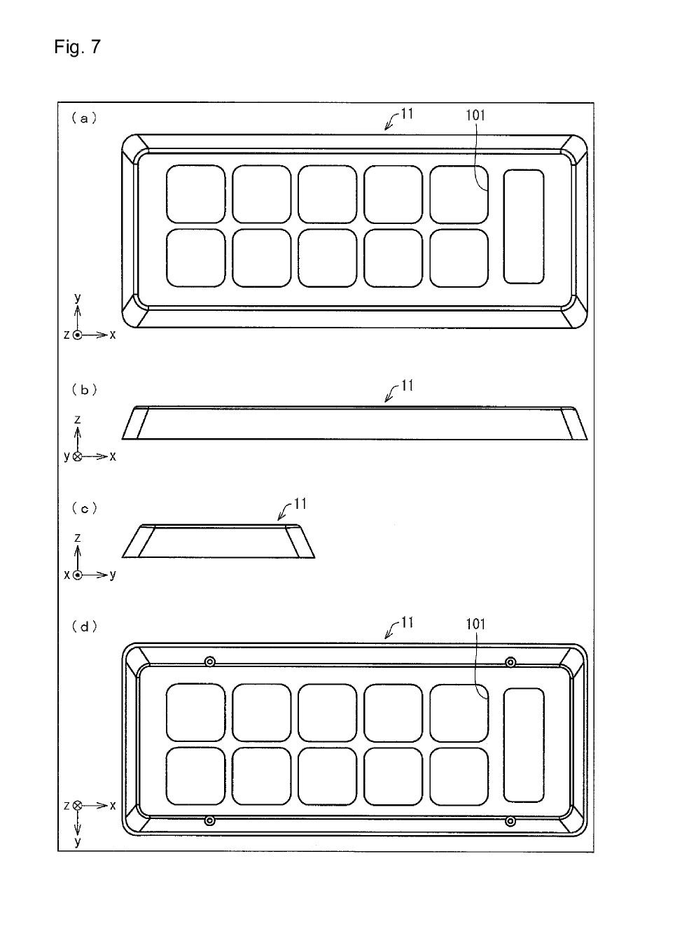

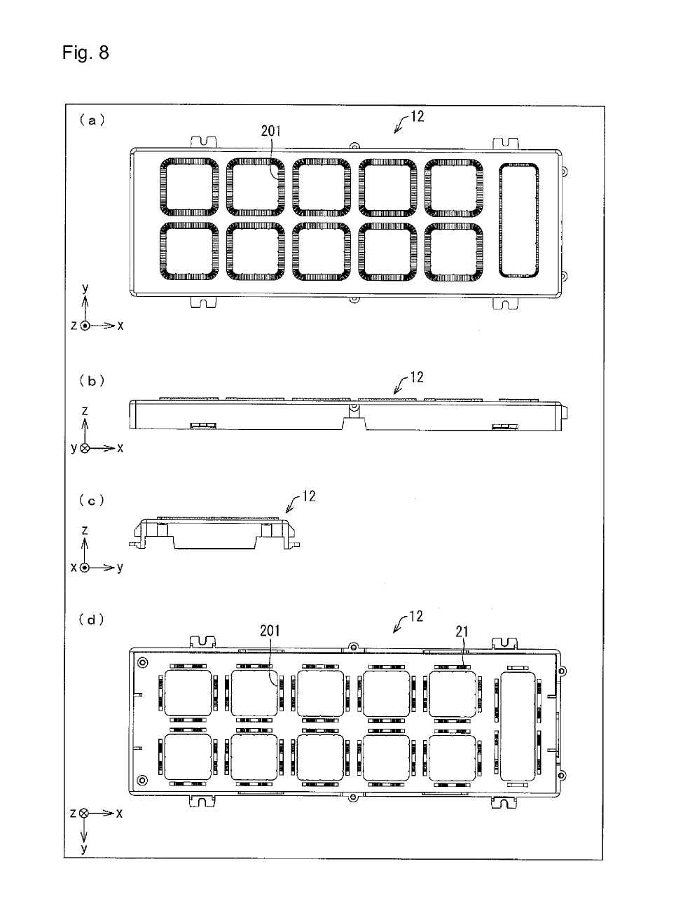

The switch unit 10 has the same number of openings 101 as the number of the operating buttons 13 and button case 12 has the same number of openings 201 as the number of the operating buttons 13, where the openings 101 and the openings 201 being formed at positions corresponding to the positions of the respective operating buttons 13, so that the operating buttons 13 protrude above the cover 11 and the button case 12 (see FIGS. 7(a) to 7(d) and 8(a) to 8(d)).

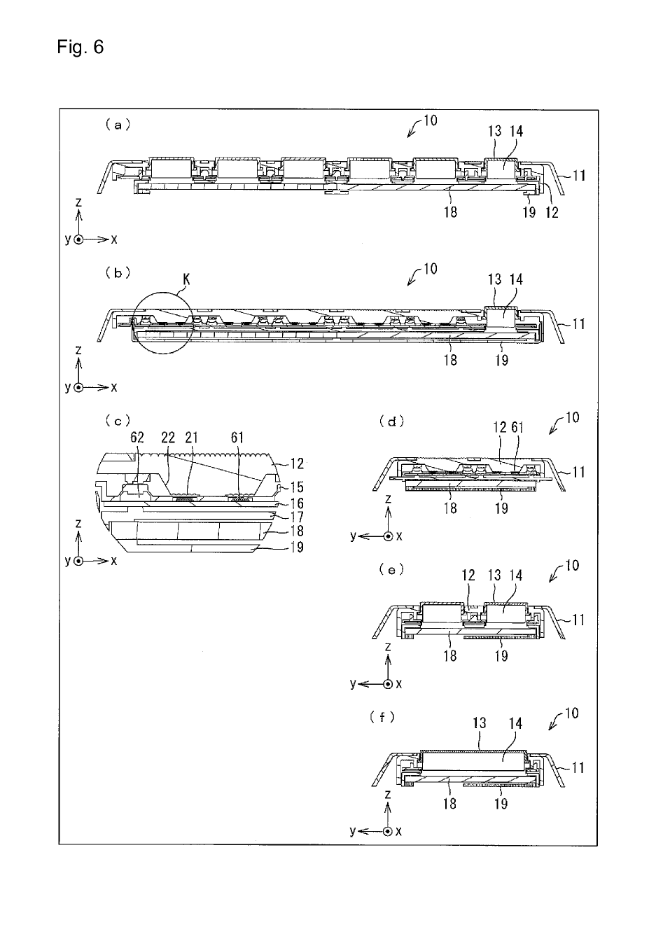

Each of the operating buttons 13 has contact portions 31 which are formed on four corners at the lower side thereof. Further, the PCB 16 has carbon contacts 62 which are provided at positions directly below the respective contact portions 31. Accordingly, when an operating button 13 is depressed, contact portions 31 of the depressed operating button 13 come into contact with carbon contacts 62 opposed thereto. In this manner, depression of the contact portions 31 can be detected (see FIGS. 6(a) to 6(f)).

The rubber 15 is arranged under (in the −z direction) the operating buttons 13. Accordingly, when an operating button 13 is depressed, the operating button 13 is pushed down in the −z direction, and then can also be pushed back in the +z direction by the rubber 15. That is, it is possible to provide a pressing feeling of the operating button 13.

Further, the inner part of each of the operating buttons 13 is formed into a cavity. Each of the lenses 14 is provided so as to be fitted into the cavity. This makes it possible to show images (pictures, characters, etc.) displayed on the LCD 18 as being displayed on the top surfaces (operating surfaces) 33 of the operating buttons 13.

In the present embodiment, there is described an example in which eleven operating buttons 13 are provided. However, the number of operating buttons 13 is not limited thereto. The number of operating buttons 13 may be less than eleven or more than eleven, or may be one.

Further, diffusion portions (light diffusion portions) 21 and light guide shapes (light guide paths) 22 are provided in the button case 12. Light emitted by light-emitting diodes (LEDs) 61 which are provided in the PCB 16 illuminate areas surrounding the respective operating buttons 13 by means of the diffusion portions 21 and the light guide shapes 22. The diffusion portions 21 and the light guide shapes 22 will be described below.

The above configuration makes it possible to give an operational feeling that cannot be provided by a touch panel to a player. In addition, the switch unit 10 is attractive to a player by showing an image displayed on the LCD 18 on the operating buttons 13 and illuminating areas surrounding the respective operating buttons 13.

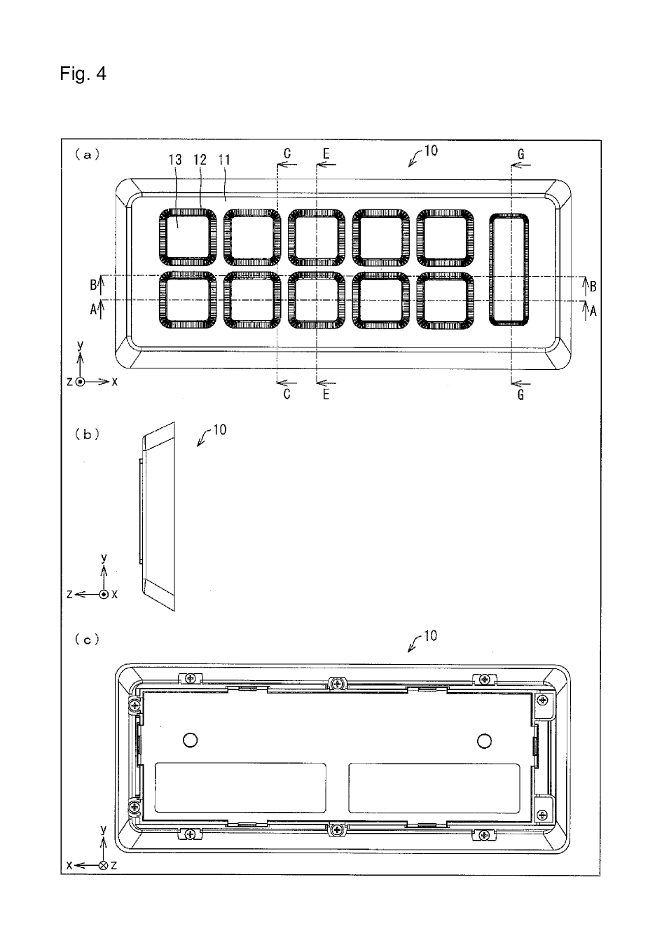

Next, the appearance of the switch unit 10 will be described with reference to FIGS. 4(a) to 4(c). FIGS. 4(a) to 4(c) are diagrams illustrating the appearance of the switch unit 10. FIG. 4(a) is a top view of the switch unit 10, FIG. 4(b) is a side view of the switch unit 10, and FIG. 4(c) is a bottom view of the switch unit 10.

As shown in FIG. 4(a), when the switch unit 10 is viewed from the upper side (+z side) thereof, the eleven operating buttons 13 are arranged thereon, and the button case 12 surrounds the operating buttons 13. Further, the cover 11 covers the button case 12. As shown in FIG. 4(b), when the switch unit 10 is viewed from the lateral side thereof, the operating buttons 13 protrude from the cover 11 in the +z direction. As shown in FIG. 4(c), when the switch unit 10 is viewed from the bottom surface thereof, the base 19 can be seen.

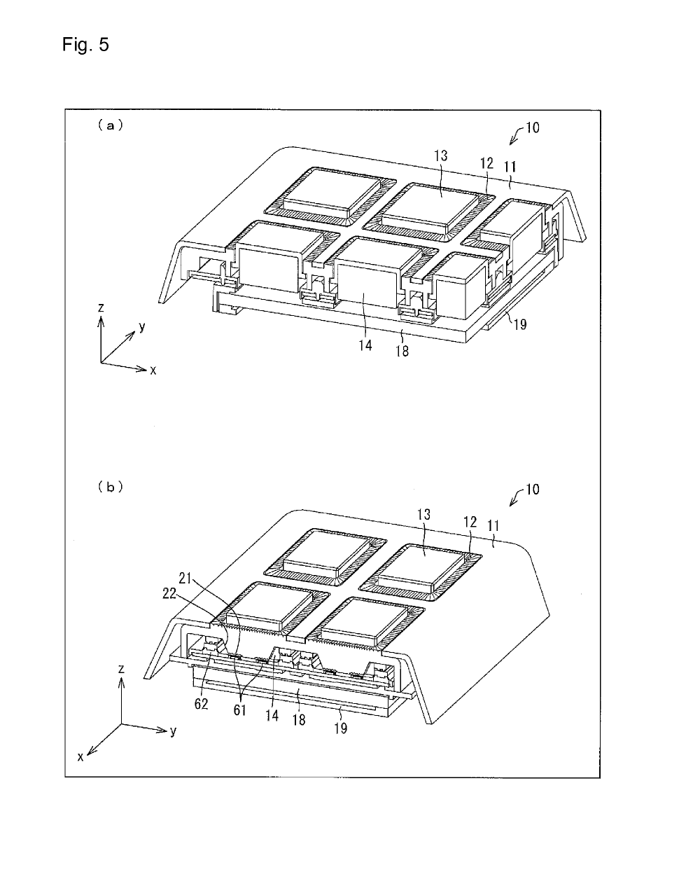

Next, the inside of the switch unit 10 will be described with reference to FIGS. 5(a) and 5(b), and 6(a) to 6(f). FIGS. 5(a) and 5(b), and 6(a) to 6(f) are cross-sectional views illustrating the internal configuration of the switch unit 10. FIGS. 5(a) and 5(b) are perspective cross-sectional views illustrating the internal configuration of the switch unit 10. FIG. 6(a) is a cross-sectional view taken along line A-A of FIG. 4(a), FIG. 6(b) is a cross-sectional view taken along line B-B of FIG. 4(a), FIG. 6(c) is an enlarged view of an area K of FIG. 6(b), FIG. 6(d) is a cross-sectional view taken along line C-C of FIG. 4(a), FIG. 6(e) is a cross-sectional view taken along line E-E of FIG. 4(a), and FIG. 6(f) is a cross-sectional view taken along line G-G of FIG. 4(a).

As shown in FIG. 5(a), in the switch unit 10, the button case 12 surrounds the operating buttons 13, and an image displayed on the LCD 18 is displayed on the top surfaces of the operating buttons 13 through the lenses 14.

As shown in FIG. 5(b), in the switch unit 10, light emitted by the LEDs 61 placed on the PCB 16 illuminates the areas surrounding the respective operating buttons 13 through the diffusion portions 21 and the light guide shapes 22. Further, the light guide shapes 22 allow light to illuminate only the areas surrounding the operating buttons 13, and do not allow light to reach the operating buttons 13 themselves.

As shown in FIGS. 6(a) and 6(b), the operating buttons 13 are positioned by the button case 12 in the x direction thereof, and the cover 11 covers the button case 12.

As shown in FIG. 6(c), the button case 12 is provided with the diffusion portions 21 which are arranged so as to face the respective LEDs 61, and the light guide shapes 22 which are arranged so as to extend around the operating buttons 13 from the diffusion portions 21. The LEDs 61 are provided in the PCB 16 at positions directly below the respective diffusion portions 21. Further, the carbon contacts 62 are provided in the PCB at positions directly below the respective contact portions 31 with the rubber 15 interposed therebetween. The rubber (elastic member) 15 is a member having elasticity. When the rubber 15 is pressed, the pressed portion tries to return to its original state. Accordingly, when an operating button 13 is depressed, contact portions 31 of the depressed operating button 13 and carbon contacts 62 opposed thereto come into contact with each other. Further, when the depression of the operating button 13 is stopped, the contact portions 31 and the carbon contacts 62 are separated from each other.

As shown in FIG. 6(d), also in the y direction, the diffusion portions 21 are provided in the button case 12 so as to face the respective LEDs 61, and the light guide shapes 22 are provided so as to extend around the operating buttons 13 from the diffusion portions 21. The LEDs 61 are provided in the PCB 16 at positions directly below the respective diffusion portions 21. Further, the carbon contacts 62 are provided in the PCB at positions directly below the respective contact portions 31 with the rubber 15 interposed therebetween.

As shown in FIGS. 6(e) and 6(f), the operating buttons 13 are positioned by the button case 12, and the cover 11 covers the button case 12.

Next, the cover 11 will be described with reference to FIGS. 7(a) to 7(d). FIGS. 7(a) to 7(d) are diagrams illustrating the appearance of the cover 11. FIG. 7(a) is a top view of the cover 11, FIG. 7(b) is a front view of the cover 11, FIG. 7(c) is a side view of the cover 11, and FIG. 7(d) is a bottom view of the cover 11.

The cover 11 is formed of, for example, a synthetic resin such as plastic. As shown in FIGS. 7(a) to 7(d), the cover 11 has the same number of openings 101 as the number of the operating buttons 13, the openings 101 being formed at positions corresponding to the positions of the respective operating buttons 13, so that the operating buttons 13 are directly exposed from the top surface of the switch unit 10.

Next, the button case 12 will be described with reference to FIGS. 8(a) to 8(d). FIGS. 8(a) to 8(d) are diagrams illustrating the appearance of the button case 12. FIG. 8(a) is a top view of the button case 12, FIG. 8(b) is a front view of the button case 12, FIG. 8(c) is a side view of the button case 12, and FIG. 8(d) is a bottom view of the button case 12.

The button case 12 is formed of, for example, glass or plastic. As shown in FIGS. 8(a) to 8(d), the button case 12 has the same number of openings 201 as the number of the operating buttons 13, the openings 201 being formed at positions corresponding to the positions of the respective operating buttons 13, so that the operating buttons 13 are directly exposed from the top surface of the switch unit 10. Further, the diffusion portions 21 and the light guide shapes 22 are provided near the respective openings 201 on the bottom surface of the button case 12.

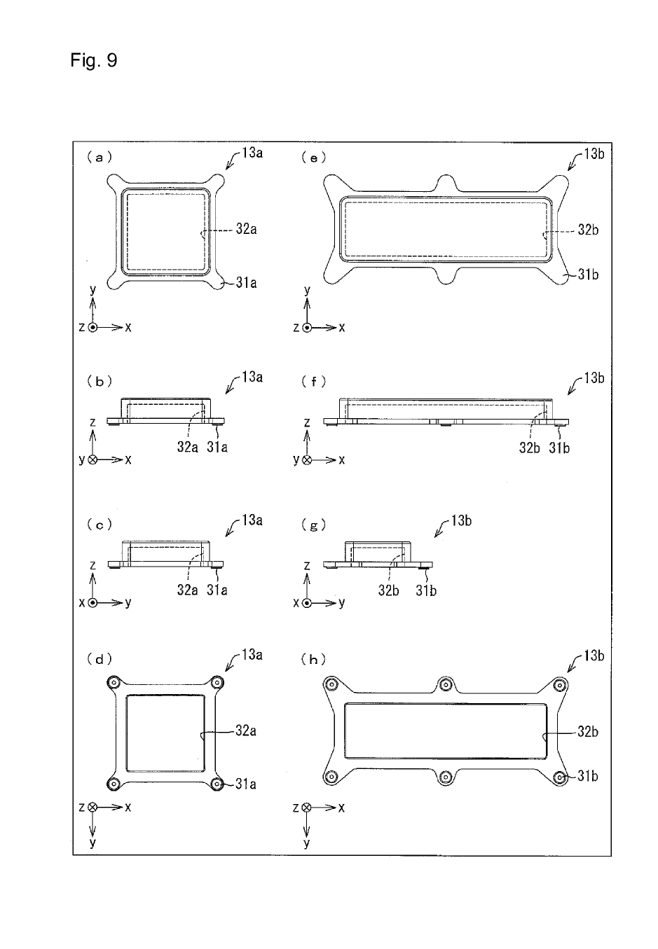

Next, the operating buttons 13 will be described with reference to FIGS. 9(a) to 9(h). FIGS. 9(a) to 9(h) are diagrams illustrating the appearance of the operating buttons 13. FIG. 9(a) is a top view of an operating button 13a that has a generally square shape when viewed from the top, FIG. 9(b) is a front view of the operating button 13a, FIG. 9(c) is a side view of the operating button 13a, FIG. 9(d) is a bottom view of the operating button 13a, FIG. 9(e) is a top view of an operating button 13b that has a rectangular shape when viewed from the top, FIG. 9(f) is a front view of the operating button 13b, FIG. 9(g) is a side view of the operating button 13b, and FIG. 9(h) is a bottom view of the operating button 13b.

The operating buttons 13 are formed of transparent plastic or the like. Therefore, an image displayed on the LCD 18 can be seen as being displayed on the top surfaces of the operating buttons 13 through the lenses 14. The operating button 13a, having a generally square shape when viewed from the top, and the operating button 13b, having a rectangular shape when viewed from the top, are collectively referred to as the operating buttons 13.

Further, each of the operating buttons 13 has a cavity 32 (32a or 32b) to which each of the lenses 14 is fitted on the bottom surface thereof. By means of the lenses 14 fitted to the respective cavities 32, an image displayed on the LCD 18 and viewed through the lenses 14 appears to be displayed on the top surfaces of the operating buttons 13.

Further, each of the operating buttons 13 has the contact portions 31 (31a or 31b) formed on the four corners of the bottom surface thereof. The operating button 13b has additional contact portions 31b formed on the central part in the longitudinal direction of the bottom surface thereof in addition to the four corners. When contact portions 31 are depressed, the depressed contact portions 31 come into contact with carbon contacts 62 opposed thereto of the PCB 16. As a result, the depression of an operating button 13 can be detected.

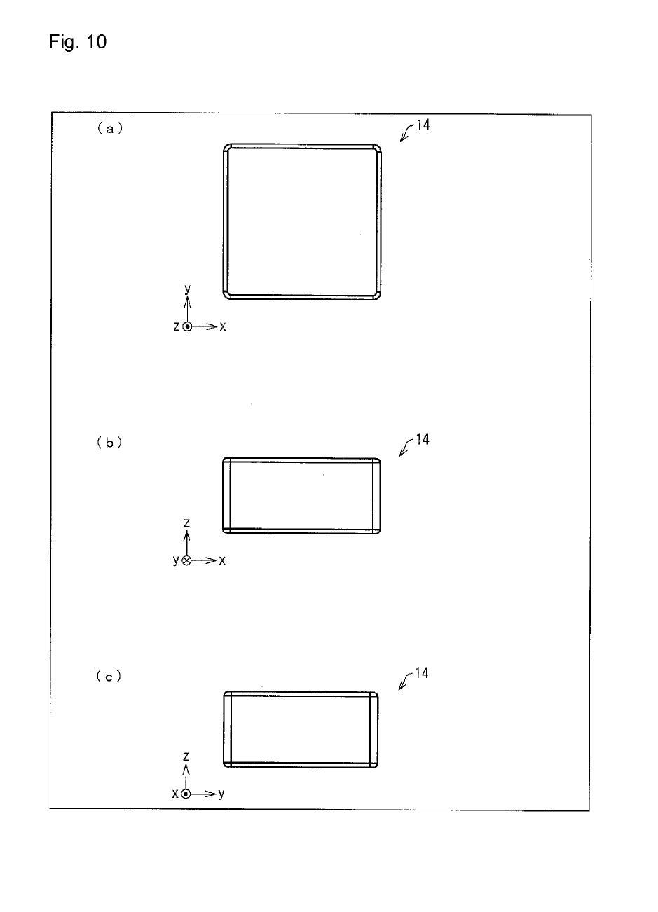

Next, the lenses 14 will be described with reference to FIGS. 10(a) to 10(c). FIGS. 10(a) to 10(c) are diagrams illustrating the appearance of the lens 14. FIG. 10(a) is a top view, FIG. 10(b) is a front view, and FIG. 10(c) is a side view. As shown in FIGS. 10(a) to 10(c), each of the lenses 14 has a cubic shape (or a rectangular parallelepiped shape (not shown)) so as to be fitted within the cavity 32 of the corresponding operating button 13. The lenses 14 are convex lenses that can show an image displayed on the LCD 18 as being displayed on the top surfaces of the operating buttons 13.

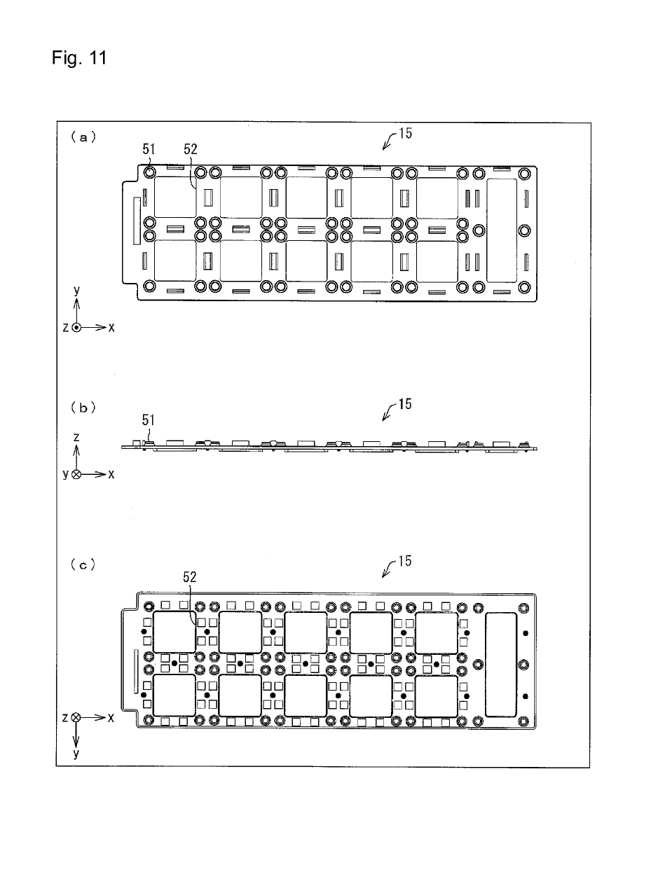

Next, the rubber 15 will be described with reference to FIGS. 11(a) to 11(c). FIGS. 11(a) to 11(c) are diagrams illustrating the appearance of the rubber 15. FIG. 11(a) is a top view, FIG. 11(b) is a front view, and FIG. 11(c) is a bottom view. The rubber 15 is an elastic member, and is transparent or nearly transparent.

As shown in FIGS. 11(a) to 11(c), the rubber 15 has openings 52 which are formed at positions corresponding to the positions of the respective operating buttons 13. Further, the rubber 15 has projections 51 which are provided at positions corresponding to the positions of the respective contact portions 31 of the operating buttons 13. The contact portions 31 of the operating buttons 13 are in contact with the respective projections 51. When an operating button 13 is depressed, contact portions 31 of the depressed operating button 13 press projections 51 that are in contact therewith. As a result, the contact portions 31 come into contact with carbon contacts 62 opposed thereto. Further, since the projections 51 have elasticity, the projections 51 press back against the contact portions 31 after being compressed by the contact portions 31. Accordingly, the operating buttons 13 serve as push buttons, that is, the operating buttons 13 resist the downward pushing motion applied by the player.

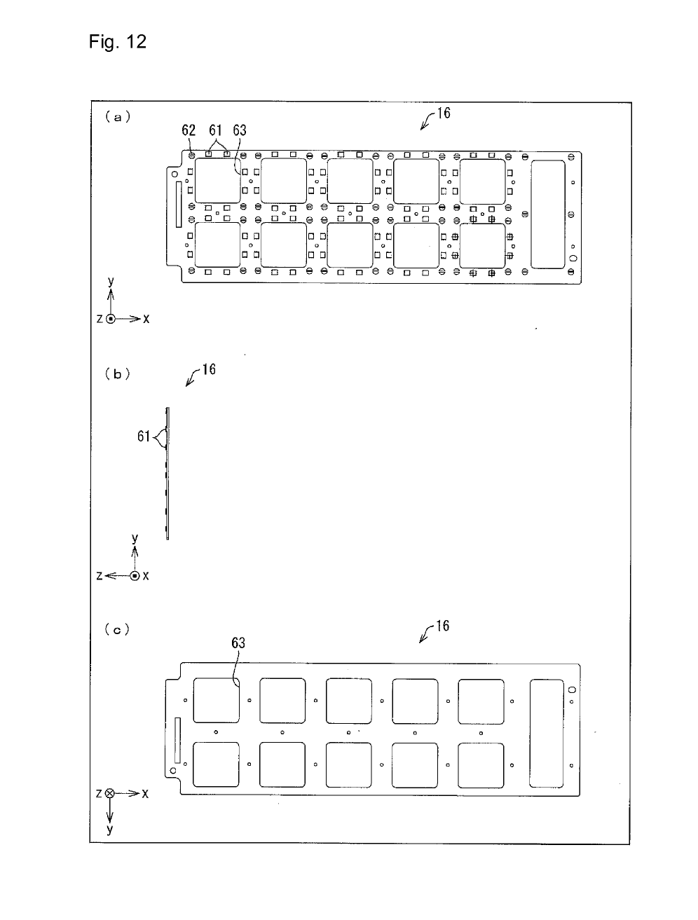

Next, the PCB 16 will be described with reference to FIGS. 12(a) to 12(c). FIGS. 12(a) to 12(c) are diagrams illustrating the appearance of the PCB 16. FIG. 12(a) is a top view, FIG. 12(b) is a side view, and FIG. 12(c) is a bottom view. The PCB 16 is a printed circuit board on which necessary wirings are formed. The PCB 16 performs predetermined processing, for example, the PCB 16 detects the depression of an operating button 13 to thereby change a display on the LCD.

As shown in FIGS. 12(a) to 12(c), the PCB 16 has openings 63 which are formed at positions corresponding to the positions of the respective operating buttons 13. In addition, the PCB 16 has the carbon contacts 62 which are provided at positions corresponding to the positions of the respective contact portions 31 of the operating buttons 13. Further, in the PCB 16, two LEDs 61 are provided at each side in the x direction and in the y direction around each of the openings 63.

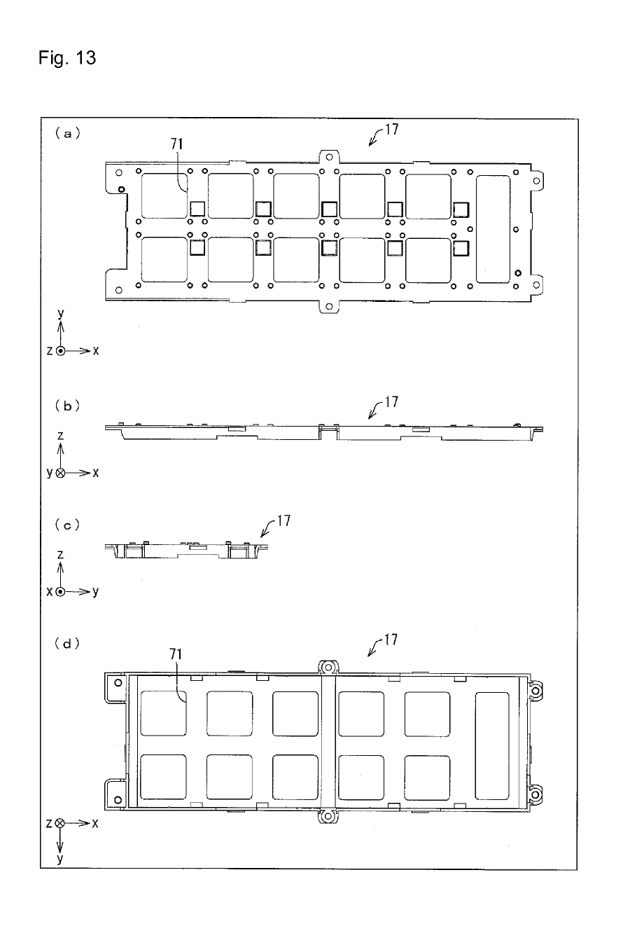

Next, the LCD case 17 will be described with reference to FIGS. 13(a) to 13(d). FIGS. 13(a) to 13(d) are diagrams illustrating the appearance of the LCD case 17. FIG. 13(a) is a top view, FIG. 13(b) is a front view, FIG. 13(c) is a side view, and FIG. 13(d) is a bottom view.

The LCD case 17 is formed of a transparent member, and has openings 71 which are formed at positions corresponding to the positions of the respective operating buttons 13 as shown in FIGS. 13(a) and 13(d).

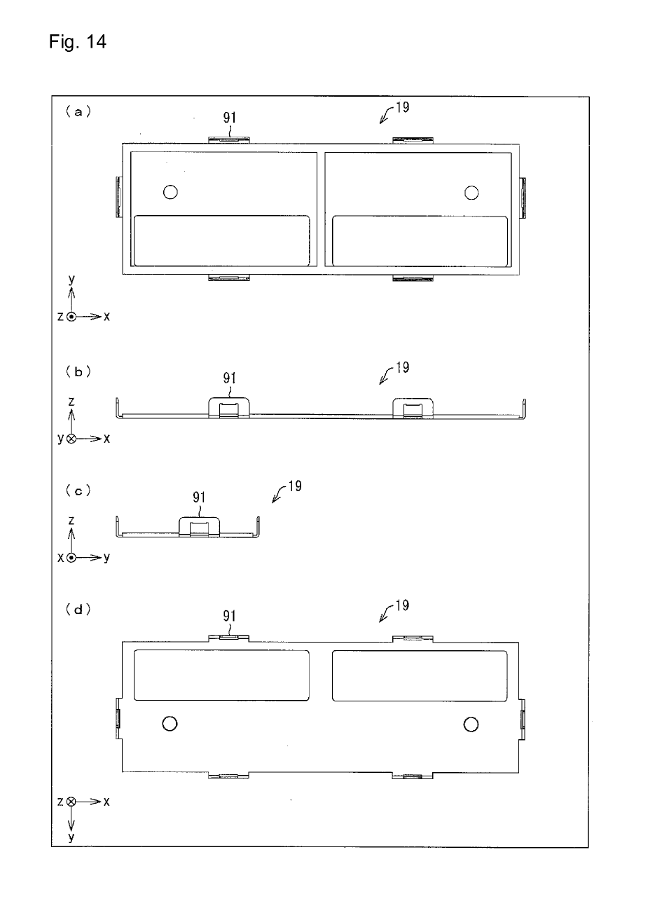

Next, the base 19 will be described with reference to FIGS. 14(a) to 14(d). FIGS. 14(a) to 14(d) are diagrams illustrating the appearance of the base 19. FIG. 14(a) is a top view, FIG. 14(b) is a front view, FIG. 14(c) is a side view, and FIG. 14(d) is a bottom view. As shown in FIGS. 14(a) to 14(d), the base 19 has LCD fixing portions 91 provided for fixing the LCD 18. More specifically, two LCD fixing portions 91 are provided at each longitudinal side of the base 19, and one LCD fixing portion 91 is provided at the center of each lateral side of the base 19.

With the above configuration, the switch unit 10 can illuminate the areas surrounding the respective operating buttons 13 and display various pieces of information (characters, pictures, etc.) on the top surfaces of the operating buttons 13 while maintaining an operational feeling, a click feeling, and a quick feeling like a push button.

Accordingly, the switch unit 10 can provide a user interface that attracts the attention of customers while maintaining the advantages of a push-button switch unit.

As described above, the switch unit 10 according to the present invention includes operating buttons 13, an LCD 18 that displays an image, lenses 14 that are disposed between the LCD 18 and the operating buttons 13, and show the image displayed on the LCD 18 as being displayed on the operating surfaces of the operating buttons 13, a PCB 16 having contacts that detect depression of an operating button 13 when the operating button 13 is depressed, and a rubber 15 that is disposed between the operating buttons 13 and the PCB 16 to make contact with both of the operating buttons 13 and the PCB 16. Accordingly, it is possible to provide a switch unit that attracts the attention of customers and give an intuitive operational feeling to customers.

The present invention is not limited to the above embodiment, and various modifications can be made within the scope defined in the claims. That is, the technical scope of the present invention also includes an embodiment obtained by combining technical means appropriately modified within the scope defined in the claims.

The present invention can be described as follows.

The switch unit according to the present invention includes an operating key, a display unit that displays an image, a lens that is disposed between the display unit and the operating key, and shows the image displayed on the display unit as being displayed on the operating surface of the operating key, a substrate having contacts that detect depression of the operating key when the operating key is depressed, and an elastic member that is disposed between the operating key and the substrate to make contact with both of the operating key and the substrate.

With the above configuration, it is possible to show a display on the display unit as being displayed on the operating surface of the operating key by the lens which is disposed between the display unit and the operating key. Therefore, it is possible to present various displays that can attract customers on the operating surface of the operating key by the display on the display unit. This makes it possible to provide a switch unit that can attract customers.

Further, since the elastic member is disposed between the operating key and the substrate, when the operating key is depressed, the elastic member is dented and then presses back the operating key. Accordingly, it is possible to give an intuitive operational feeling, a quick feeling, and a click feeling of depressing the operating key to a player. In addition, since an operation can be performed by a physical action as depressing the operating key, it is not necessary to visually confirm whether the operation has been completed in each operation. Therefore, a switch unit that can give a speed feeling and a click feeling to a player can be provided.

The switch unit according to the present invention may include a light emitting unit that is disposed on the substrate and emits light having directivity, and an operating key case that positions the operating key. The operating key case may include a light diffusion portion that diffuses light emitted by the light emitting unit and a light guide path that guides the light diffused by the light diffusion portion to an area surrounding the operating key.

With the above configuration, it is possible to illuminate the area surrounding the operating key by the light emitting unit. Therefore, it is possible to highlight only a particular operating key. As a result, it is possible to provide a switch unit that further attracts the attention of customers.

In addition, by means of the light guide path, a display displayed on the operating surface of the operating key and light emitted by the light emitting unit do not interfere with each other. Therefore, the display unit and the light emitting unit can independently perform display and light emission, respectively. This makes it possible to present variety of displays, and thereby provide a switch unit that further attracts the attention of customers.

In the switch unit according to the present invention, a plurality of the light emitting units may be provided on the substrate.

With the above configuration, since the plurality of light emitting units are provided, the configuration of the light guide path for guiding light to the area surrounding the operating key can be simplified.

A game machine that is equipped with the above switch unit can achieve the above effects.

Since the prevent invention gives an intuitive operational feeling to a player and attracts the attention of customers, the present invention is suitable not only for a slot machine, but also for a poker game machine, a mahjong game machine, a card game machine, and the like.

1. A switch unit comprising:
an operating key;
a display unit configured to display an image;
a lens disposed between the display unit and the operating key, the lens configured to provide the appearance that the image displayed on the display unit is displayed on an operating surface of the operating key;
a substrate having contacts, the contacts configured to detect depression of the operating key when the operating key is depressed; and
an elastic member disposed between the operating key and the substrate to make contact with both of the operating key and the substrate.

2. The switch unit according to claim 1, further comprising:
a light emitting unit disposed on the substrate, the light emitting unit configured to emit light having directivity; and
an operating key case that positions the operating key, wherein
the operating key case includes a light diffusion portion configured to diffuse light emitted by the light emitting unit and a light guide path configured to guide the light diffused by the light diffusion portion to an area surrounding the operating key.

3. The switch unit according to claim 2, wherein a plurality of the light emitting units are provided on the substrate.

4. A game machine equipped with the switch unit according to claim 1.

5. A game machine equipped with the switch unit according to claim 2.

6. A game machine equipped with the switch unit according to claim 3.
